(19) United States
(12) Patent Application Publication
(10) Pub. No.: US 2011/0210188 A1
(43) Pub. Date: Sep. 1, 2011

(54) OVERHEAD SHOWER WITH LCD

(75) Inventors: Hua Yao, Xiamen (CN); Xianguo Zou, Xiamen (CN)

(73) Assignee: XIAMEN SOLEX HIGH-TECH INDUSTRIES CO., LTD., Fujian (CN)

(21) Appl. No.: 13/127,563

(22) PCT Filed: Nov. 27, 2009
(86) PCT No.: PCT/CN2009/075171

§ 371 Date: May 4, 2011

(30) Foreign Application Priority Data
Jan. 14, 2009 (CN) 200920136388.2

(51) Int. Cl. B67D 7/08

(52) U.S. Cl. 239/71

(57) ABSTRACT

An overhead shower with LCD, has a water outlet device connected with the main body of the shower. A hydroelectric device and a thermistance are disposed in the main body. A display module connected with one side of the main body has a circuit board and an LCD screen which are electrically connected with the hydroelectric device and the thermistance. When water flows into the main body, the hydroelectric device supplies power for display module, and the thermistance transmits the temperature information to the display module, so that the temperature is shown on the LCD screen. Therefore the outflow temperature is shown on the LCD screen so that the user can clearly read the outflow temperature of the shower.

### FIELD OF THE INVENTION

The present invention relates to a sanitary ware, especially relates to an overhead shower with LCD.

### BACKGROUND OF THE INVENTION

The shower is applied for bath, so the outflow temperature of the shower will directly determine whether the bath is comfortable or not. Generally, when the user takes a bath, he needs to continuously adjust the outflow temperature and feel the water with his body, until the temperature is suitable for shower. However, there are some shortages in the conventional technique, it is difficult for the user to estimate the outflow temperature at the first adjustment, so he may be hurt by the hot outflow, or feel quite uncomfortable if the outflow water is too cold. In order to solve the above shortage, people equip a LCD screen on the shower main body for illustrating the outflow temperature. However, the LCD screen is usually disposed on the rear portion of the shower main body or on the shower handle, and the size of the LCD screen is small, it is inconvenient for the user to know the outflow temperature.

### SUMMARY OF THE INVENTION

The object of the present invention is to provide an overhead shower with LCD, which can clearly show the outflow temperature of overhead shower.

The technical solution of the present invention is:

Overhead shower with LCD, said shower comprises a main body and a water outlet device connected with the main body, a hydroelectric device and a thermistance are disposed in said main body; a display module is connected with one side of the main body, said display module comprises a circuit board, a LCD screen; the circuit board and the LCD screen are electrically connected with the hydroelectric device and the thermistance in the main body with wire.

Said hydroelectric device comprises a generator coil, a magnet and an impeller which can drive the magnet rotate.

An inclined water body is disposed on the water inlet of the main body for adjusting water flow.

A pivoted hole is disposed on one side of the main body for pivoting the display module.

The display module comprises a circuit board, a LCD screen, a window lens and a housing, a pivoting seat is formed on the rear portion of the housing, a window for fixing the window lens is formed under the housing, the LCD screen and the circuit board are sequentially disposed behind the window lens and in the housing.

The main body is pivoted with the display module by a hollow pivot.

After applying the present technical solution, the present invention arranges a display module on one side of the main body of the overhead shower, said display module is electrically connected with the hydroelectric device and the thermistance in the main body, so when the water flows into the overhead shower main body, the hydroelectric device will supply power to the circuit board and the LCD screen, while the thermistance will transmit the temperature parameter to the circuit board, then the circuit board will transmit the temperature parameter to the LCD screen, therefore the outflow temperature will be illustrated on the LCD screen, since the display module is disposed outside of the shower main body, so the user can clearly observe the displaying temperature. Furthermore, since said display module is movably pivoted with the main body, so the display module can rotate relative to the main body, and it will be convenient for the user to adjust the observation angle.

### BRIEF DESCRIPTION OF THE DRAWINGS

FIG. 1 is the perspective view of the present invention;

FIG. 2 is the bottom view of the present invention;

FIG. 3 is the top view of the present invention;

FIG. 4 is the structural view of the present invention;

FIG. 5 is the partial structural view of the present invention.

### DETAILED DESCRIPTION OF THE EMBODIMENTS

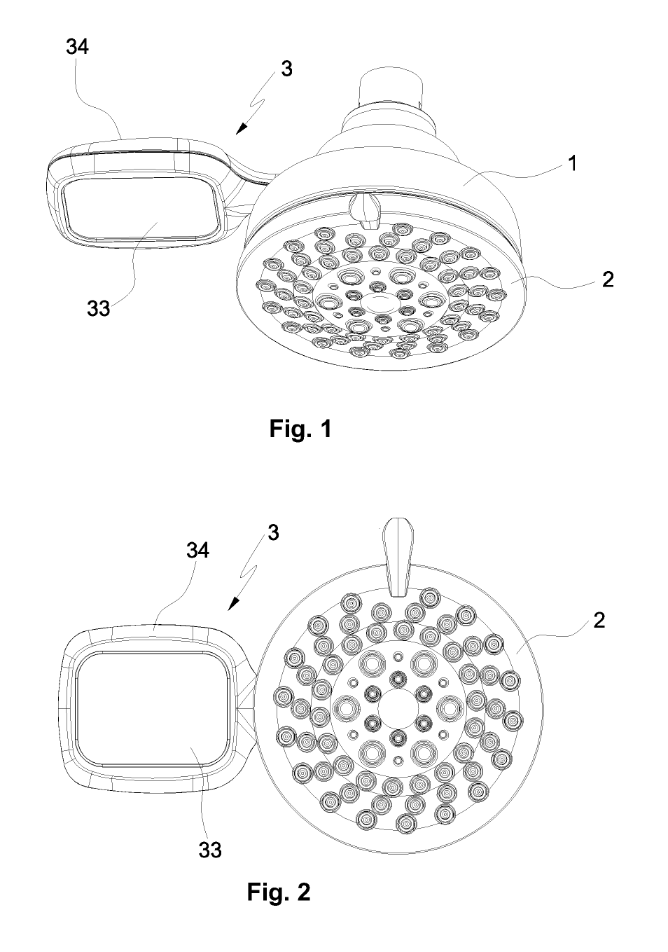

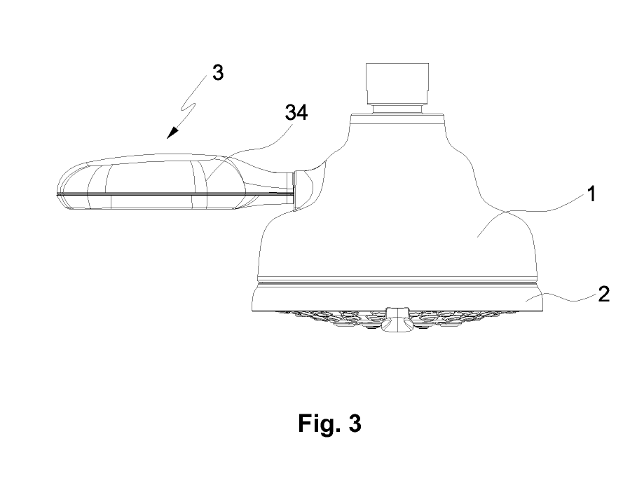

The overhead shower with LCD of the present invention is showed in FIG. 1 to FIG. 5, said shower comprises a main body 1 and a water outlet device 2 connected with the main body 1, the key technical feature of the present invention is: a display module 3 is connected with one side of the main body 1.

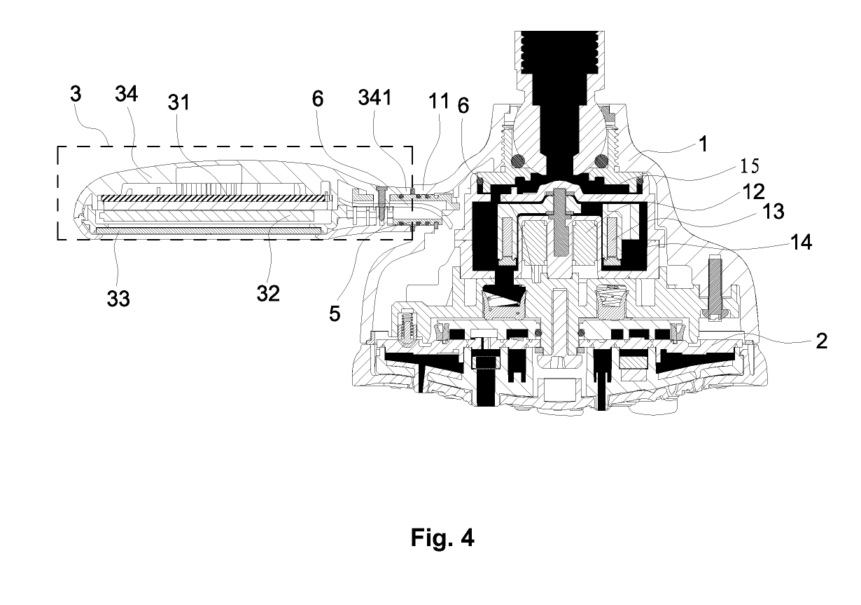

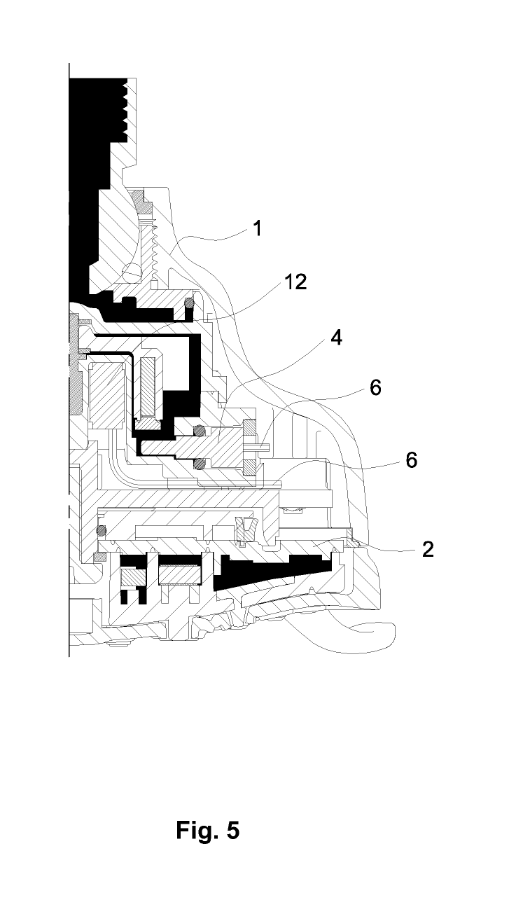

As showed in FIG. 4 and FIG. 5, an inclined water body 15 is disposed on the water inlet of the main body 1, a generator coil 12 is disposed under the inclined water body 15, a magnet 13 is arranged on the outer periphery of the coil 12, the magnet 13 is installed in the impeller 14, so the hydroelectric device is formed. The water outlet device 2 is disposed under the hydroelectric device 4, a thermistance 4 is disposed in the main body 1 and electrically electrically connected with the hydroelectric device and the display module 3.

A pivoted hole 11 for pivoting the display module 3 is disposed on one side of the main body 1.

Said display module 3 mainly comprises a circuit board 31, a LCD screen 32, a window lens 33 and a housing 34, a pivoting seat 341 is formed on the rear portion of the housing 54, a window for fixing the window lens 33 is formed on the lower portion of the housing 34, the LCD screen 32 and the circuit board 31 are sequentially disposed on the rear portion of the window lens 33 and in the housing 34.

The two ends of the hollow pivoting shaft 5 are respectively fixed in the pivoting hole 11 of the shower main body 1 and the pivoting seat 341 of the housing 34, so the display module 3 is movably pivoted with the main body 1, and the electric wire 6 for the circuit board 31, the LCD screen 32, the hydroelectric device and the thermistance 4 passes through the hollow pivoting shaft 5 for electric connection.

After the water flows into the shower main body 1, the inclined water body 15 will adjust the water, then the adjusted water will exert a sideway impact force to the impeller 14, the impeller 14 will be driven to rotate, the magnet 13 disposed inside the impeller 14 will rotate relative to the coil 12 along with the impeller 14 and cut the magnetic lines, so induced electromotive force will be generated on the coil 12 and led out by the wire 6, thus electric current will be generated in the circuit board loop for supplying the power to the circuit board 31 and the LCD screen 32. Since the resistance of the thermistance 4 will change according to the temperature change of the water flow, the change is identified by the software, the thermistance 4 is connected with the circuit board 31 through the wire 6, so the temperature will be illustrated on the LCD screen 32 correspondingly. Therefore when the user opens the water supply switch for overhead shower, the outflow temperature will be directly showed on the display module 3 outside of the shower main body 1. Furthermore, said display module 3 is movably pivoted with the main body 1, so the display module 3 can rotate relative to the main body 1, so it is convenient for the user to adjust the viewing angle. The size of the LCD screen 52 can be designed relatively large since the display module 3 is connected outside of the shower main body 1, so the user can clearly observe the outflow temperature of the shower.

### INDUSTRIAL APPLICABILITY

The present invention discloses an overhead shower with LCD, which applies its own hydroelectric device for power supply, the outflow temperature of the shower is legibly showed, the structure is simple. The present invention performs well, it has a good industrial applicability.

1. Overhead shower with LCD, said shower comprises a main body and a water outlet device connected with the main body, a hydroelectric device and a thermistance are disposed in said main body; wherein a display module is connected with one side of the main body, said display module comprises a circuit board, a LCD screen; the circuit board and the LCD screen are electrically connected with the hydroelectric device and the thermistance in the main body with wire.

2. The overhead shower with LCD according to claim 1, wherein said hydroelectric device comprises a generator coil, a magnet and an impeller which can drive the magnet rotate.

3. The overhead shower with LCD according to claim 1, wherein an inclined water body is disposed on the water inlet of the main body for adjusting water flow.

4. The overhead shower with LCD according to claim 2, wherein the generator coil and the magnet around the outer periphery of the generator coil are disposed under the inclined water body, the magnet is disposed in the impeller; the water flow will exert a sideway impact force to the impeller after being adjusted by the inclined water body, then drive the impeller to rotate, and the magnet will cut magnetic lines when the impeller rotates relative to the coil, so induced electromotive force will be generated on the coil and led out by the wire, thus electric current will be generated in the circuit board loop for supplying the power to the circuit board and the LCD screen.

5. The overhead shower with LCD according to claim 1, wherein a pivoted hole is disposed on one side of the main body for pivoting the display module.

6. The overhead shower with LCD according to claim 1, wherein the display module comprises a circuit board, a LCD screen, a window lens and a housing, a pivoting seat is formed on the rear portion of the housing, a window for fixing the window lens is formed under the housing, the LCD screen and the circuit board are sequentially disposed behind the window lens and in the housing.

7. The overhead shower with LCD according to claim 1, wherein the main body is pivoted with the display module by a hollow pivot.

8. The overhead shower with LCD according to claim 3, wherein the generator coil and the magnet around the outer periphery of the generator coil are disposed under the inclined water body, the magnet is disposed in the impeller; the water flow will exert a sideway impact force to the impeller after being adjusted by the inclined water body, then drive the impeller to rotate, and the magnet will cut magnetic lines when the impeller rotates relative to the coil, so induced electromotive force will be generated on the coil and led out by the wire, thus electric current will be generated in the circuit board loop for supplying the power to the circuit board and the LCD screen.
